(19) United States
(12) Patent Application Publication
(10) Pub. No.: US 2016/0279668 A1
(43) Pub. Date: Sep. 29, 2016

(54) DEVICE, DEVICE SHELL AND ITS PROCESSING METHOD

(71) Applicant: Xiaomi Inc., Beijing (CN)

(72) Inventors: Xiaodong SHANG, Beijing (CN); Shuo ZHANG, Beijing (CN); Zhuxin LI, Beijing (CN); Guohua WANG, Beijing (CN)

(73) Assignee: Xiaomi Inc.

(21) Appl. No.: 15/074,901

(22) Filed: Mar. 18, 2016

(30) Foreign Application Priority Data
Mar. 23, 2015 (CN) 201510128804.4

(51) Int. Cl. B05D 1/02; H01Q 1/24

(52) U.S. Cl. CPC B05D 1/02; H01Q 1/243

(57) ABSTRACT

A method for processing a device shell, includes: applying an ink layer onto a film to form a membrane; attaching the membrane to an outer surface of the device shell; and removing the film from the membrane attached to the outer surface, such that the ink layer remains on the outer surface.

### CROSS-REFERENCE TO RELATED APPLICATIONS

This application is based on and claims priority to Chinese Patent Application No. CN201510128804.4, filed Mar. 23, 2015, the entire contents of which are incorporated herein by reference.

### TECHNICAL FIELD

The present disclosure generally relates to the field of shell manufacturing technology, and more particularly, to a device shell and a method for processing the same, as well as a device.

### BACKGROUND

Conventionally, a device with a function of communicating or networking, such as a mobile phone and a tablet computer, may need to be installed with an antenna inside the device shell. Some device makers use a metal material to manufacture the device shell to achieve an aesthetic appearance of the device shell, so as to satisfy users' need for nice-looking appearance of the device shell. However, for an antenna to effectively transmit signals, a metal shell may need to be divided into several independent parts with insulating material disposed therebetween. Therefore, the metal shell of the device may need additional insulating material, generally a plastic material, to form partitions between parts of the shell, to meet the requirement for the antenna to transmit signals. Such configuration adversely affects the uniformity and aesthetic aspects of the appearance of the device shell.

### SUMMARY

According to one aspect of the present disclosure, there is provided a method for processing a device shell. The method includes: applying an ink layer onto a film to form a membrane; attaching the membrane to an outer surface of the device shell; and removing the film from the membrane attached to the outer surface, such that the ink layer remains on the outer surface.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for processing a device shell, according to an exemplary embodiment of the present disclosure.

FIG. 2 is a schematic diagram showing a cross-sectional view of a membrane, according to an exemplary embodiment of the present disclosure.

FIG. 3 is a schematic diagram showing a cross-sectional view of a portion of a device shell, according to an exemplary embodiment of the present disclosure.

FIG. 4 is a schematic diagram showing a cross-sectional view of a portion of the device shell shown in FIG. 3A after a film is removed, according to an exemplary embodiment of the present disclosure.

FIG. 5 is a flow chart showing a method for processing a device shell, according to another exemplary embodiment of the present disclosure.

FIGS. 6A and 6B are schematic diagrams showing cross-sectional views of a device shell, according to an exemplary embodiment of the present disclosure.

FIG. 7 is a schematic diagram showing a plan-view of a device shell, according to another exemplary embodiment of the present disclosure.

FIG. 8 is a block diagram of a device according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

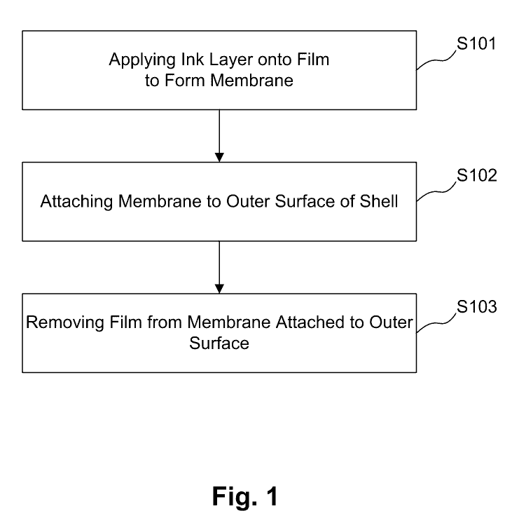

FIG. 1 is a flow chart showing a method 100 for processing a device shell, according to an exemplary embodiment of the present disclosure. As shown in FIG. 1, the method 100 can be used for manufacturing a device shell, and includes the following steps S101 to S103.

In step S101, an ink layer is applied onto a film to form a membrane.

In an embodiment, the ink is stirred sufficiently in advance, so that the ink may be of a uniform density; before the ink layer is applied onto the film to form the membrane.

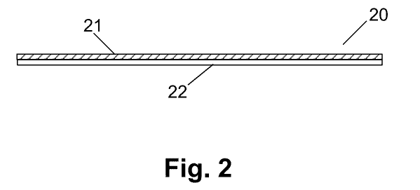

In an embodiment, the ink layer is of a thickness ranging from 0.002 mm to 0.2 mm. FIG. 2 is a schematic diagram showing a cross-sectional view of a membrane 20 including a film 21 and an ink layer 22, according to an exemplary embodiment.

In step S102, the membrane is attached to an outer surface of a shell. In some embodiments, the ink layer of the membrane is in contact with the outer surface.

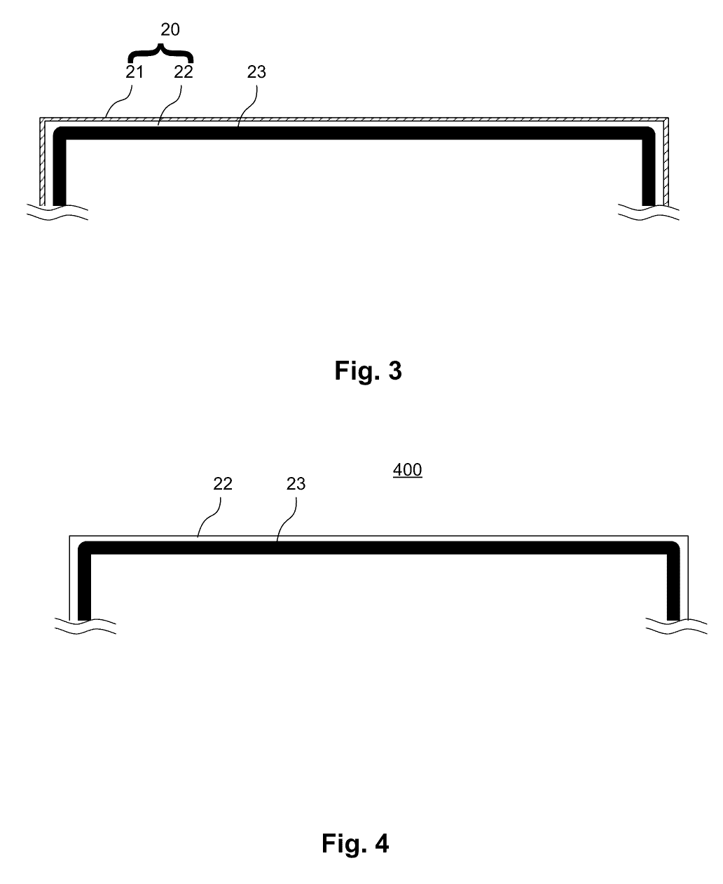

FIG. 3 is a schematic diagram showing a cross-sectional view of a portion of a shell 23 after it is processed by step S102, according to an exemplary embodiment.

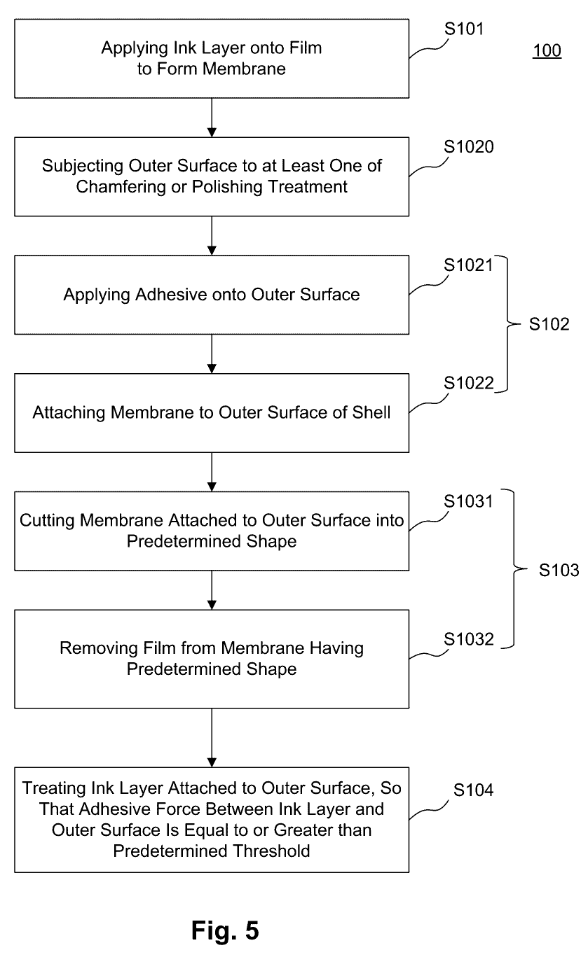

In step S103, the film 21 is removed from the membrane 20 attached to the outer surface, leaving the ink layer 22 to remain on the outer surface of the shell 23. FIG. 4 is a cross-sectional view of a portion of the device shell of a device 400, according to an exemplary embodiment. The device shell of the device 400 has the shell 23 coated with the ink layer 22.

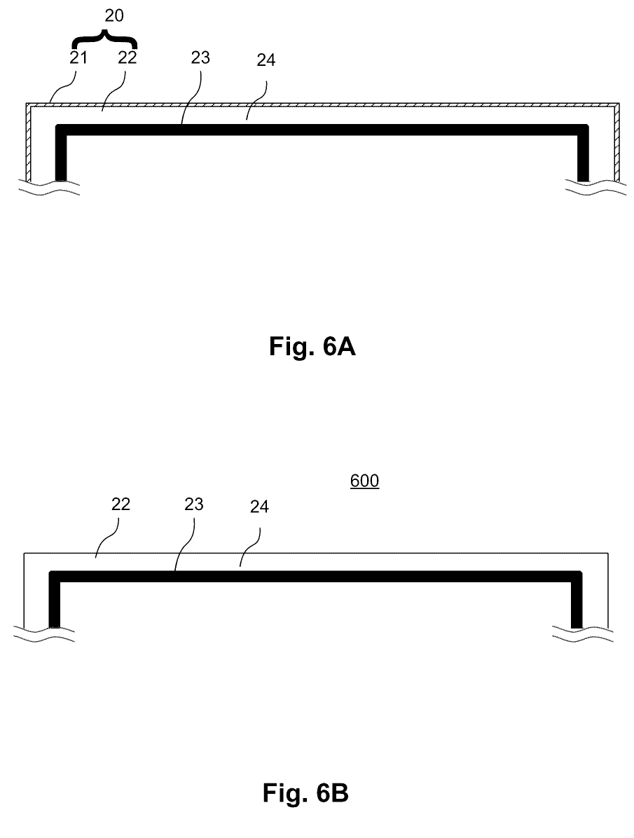

In another embodiment, step S102 of the method 100 may include steps S1021 and S1022. Referring to FIGS. 5 and 6A, in step S1021, an adhesive 24, such as glue, is coated onto the outer surface of the shell 23 by, for example, spraying. In step S1022, the membrane 20 is attached to the outer surface of the shell 23 coated with the adhesive 24, such that the ink layer 22 of the membrane 20 is attached to the outer surface via the adhesive 24. In one embodiment, the adhesive 24 is of a thickness ranging from 0.002 mm to 0.2 mm. In some embodiments, the membrane 20 may be attached to the shell 23 using a molding tool, and the membrane 20 may be conveyed and aligned to the shell 23 coated with the adhesive 24 by film feeding and positioning machines, respectively. The membrane 20 may be attached to the outer surface of the shell 23 using the adhesive 24 or other means, consistent with the scope of embodiments of the present disclosure.

In an embodiment, referring to FIG. 5, prior to step S102, the method 100 may further include step S1020. In step S1020, the outer surface of the shell 23 may be subject to at least one of chamfering or polishing treatment, to at least in part facilitate attaching the membrane 20 to the outer surface of the shell 23.

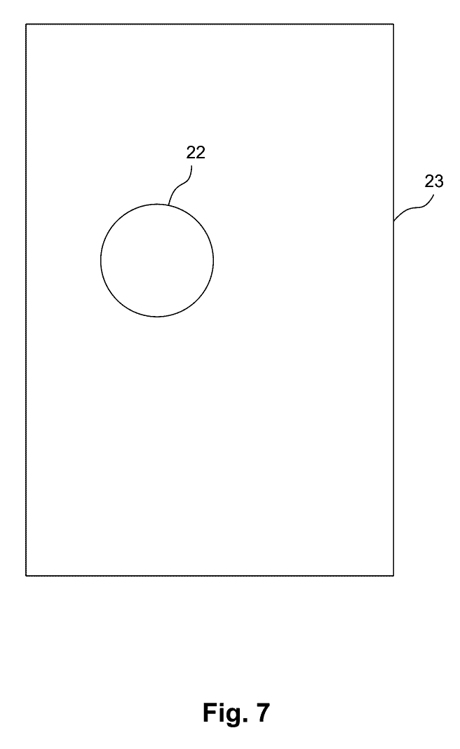

In an embodiment, as shown in FIG. 5, step S103 of the method 100 may include steps S1031 and S1032. In step S1031, the membrane 20 attached to the outer surface is cut into a predetermined shape. In step S1032, the film 21 having the predetermined shape is removed from the outer surface of the shell 23, leaving the ink layer 22 having the predetermined shape to remain on the outer surface. The predetermined shape may be any shape as required. For example, the predetermined shape may be similar or substantially identical to that of the outer surface, so that the ink layer 22 may fully cover the outer surface of the shell 23, as shown in FIG. 6B. FIG. 6B is a schematic diagram showing a cross-sectional view of the device shell of a device 600, according to an exemplary embodiment. The device shell of the device 600 has the shell 23 coated with the adhesive 24 and the ink layer 22. For another example, the predetermined shape may be smaller than that of the shell 23, so that the ink layer 22 covers a portion of the outer surface, as shown in FIG. 7. FIG. 7 is a schematic diagram showing a plan-view of the device shell of a device 700, according to an exemplary embodiment. The device shell of the device 700 has the shell 23 with the ink layer 22 of a circular shape coving a region of the outer surface of the shell 23.

In one embodiment, referring back to FIG. 5, the method 100 may further include step S104 after step S103. In step S104, the ink layer 22 attached to the outer surface of the shell 23 is further treated, so that an adhesive force between the ink layer 22 and the outer surface is equal to or greater than a predetermined threshold. This is to satisfy the requirements for an improved adhesive force and to prevent the ink layer 22 from peeling off from the shell 23. For example, a reinforcement treatment may be processes such as cooling or repeated heat treatments.

It should be noted that the device shell according to embodiments of the present disclosure may be made of any material, such as a metal or plastic material. The shell may be in any shape, and provided with other components such as a partition. The ink layer according to embodiments of the present disclosure may be a metallic ink layer. The metallic ink refers to an ink containing fine metal flakes, instead of a pigment or a dye in a traditional ink, allowing for a particular metal-shining effect. As a result, the metallic ink layer makes the device shell look metallic as a whole or in a certain region. In some embodiments, the ink layer may be made of an adhesive coating material capable of adhering to the outer surface of the shell. In other embodiments, the ink layer may be an ink layer that makes the outer surface of the shell look textured or woody, depending on different appearance requirements.

According to embodiments of the present disclosure, the outer surface of a device shell may be coated with an ink layer, to make the appearance of device shell look uniform, regardless of the material or the shape of the device shell, to show various textured appearances, to accommodate various materials of the shells, and to improve the aesthetic aspect of the shell.

For example, the ink layer may be a metallic ink layer, allowing the device shell to be of a metallic appearance as a whole or in a predetermined region, and thereby improving the aesthetic aspect of the device shell. As described above, for an antenna to effectively transmit signals, a metal shell may need to be divided into several independent parts with an insulating material disposed therebetween. Therefore, the metal shell of the device may need additional insulating material, generally a plastic material, to form partitions between parts of the shell, to meet the requirement for the antenna to transmit signals. As a result, the device shell may not display a metallic texture as a whole. However, a device shell processed according to embodiments of the present disclosure can not only meet the requirements for the antenna to transmit signals, but also display the metallic texture appearance as a whole, thereby preventing the partition from being observed from outside, and improving the aesthetic aspect.

The present disclosure further provides a device shell processed by the methods described above. An outer surface of the shell is coated with an ink layer, e.g., as shown in FIGS. 4, 6B, and 7.

In an embodiment, the ink layer is of a thickness ranging from 0.002 mm to 0.2 mm.

The present disclosure further provides exemplary devices, such as devices 400, 600, and 700 shown in FIGS. 4, 6B, and 7, including a device shell provided by embodiments of the present disclosure.

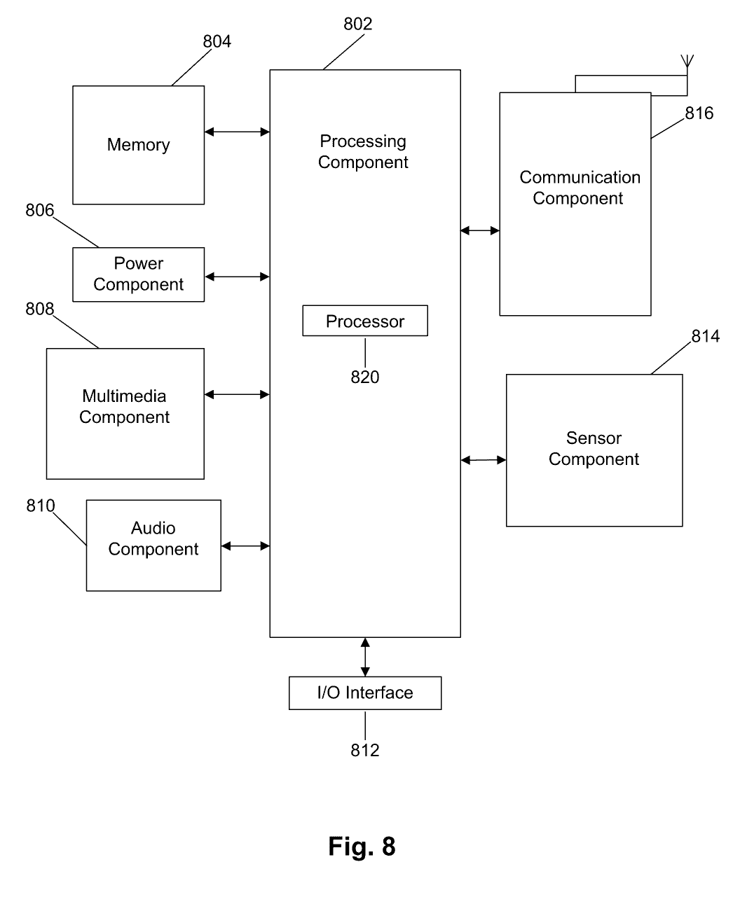

FIG. 8 is a block diagram of a device 800 according to an exemplary embodiment. For example, the device 800 may be a mobile phone, a computer, a digital broadcasting terminal, a messaging device, a game console, a tablet device, fitness equipment, a Personal Digital Assistant PDA, etc. The device 800 has a device shell provided according to the embodiments of the present disclosure.

Referring to FIG. 8, the device 800 may include the following one or more components: a processing component 802, a memory 804, a power component 806, a multimedia component 808, an audio component 810, an Input/Output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 808 includes a front camera and/or a rear camera. The front camera and the rear camera may receive external multimedia data while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone configured to receive an external audio signal when the intelligent device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface for the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800 and relative positioning of components (e.g. the display and the keypad of the device 800). The sensor component 814 may also detect a change in position of the device 800 or of a component in the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the device 800 and other devices. The device 800 can access a wireless network based on a communication standard, such as WIFI, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as the memory 804 including instructions. The above instructions are executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as illustrative only, with a true scope and spirit of the invention being indicated by the following claims.

It will be appreciated that the present invention is not limited to the exact construction that has been described above and illustrated in the accompanying drawings, and that various modifications and changes can be made without departing form the scope thereof. It is intended that the scope of the invention only be limited by the appended claims.

What is claimed is:

1. A method for processing a device shell, comprising:
applying an ink layer onto a film to form a membrane;
attaching the membrane to an outer surface of the device shell; and
removing the film from the membrane attached to the outer surface, such that the ink layer remains on the outer surface.

2. The method according to claim 1, wherein attaching the membrane to the outer surface of the device shell comprises:
coating an adhesive onto the outer surface; and
attaching the membrane to the outer surface coated with the adhesive,
wherein the ink layer of the membrane is in contact with the adhesive.

3. The method according to claim 1, wherein removing the film from the membrane attached to the outer surface comprises:
cutting the membrane attached to the outer surface into a predetermined shape; and
removing the film from the membrane attached to the outer surface, such that the ink layer having the predetermined shape remains on the outer surface.

4. The method according to claim 1, wherein after removing the film from the membrane attached to the outer surface, the method further comprises:
treating the ink layer attached to the outer surface, so that an adhesive force between the ink layer and the outer surface is equal to or greater than a predetermined threshold.

5. The method according to claim 1, wherein prior to attaching the membrane to the outer surface of the device shell, the method further comprises:
subjecting the outer surface to at least one of chamfering treatment or polishing treatment.

6. The method according to claim 1, wherein the ink layer is of a thickness ranging from 0.002 mm to 0.2 mm.

7. The method according to claim 2, wherein the adhesive is of a thickness ranging from 0.002 mm to 0.2 mm.

8. The method according to claim 1, wherein the ink layer comprises a metallic ink layer.

9. A device shell processed by the method according to claim 1, wherein the outer surface of the device shell is coated with the ink layer.

10. The device shell according to claim 9, wherein the ink layer is of a thickness ranging from 0.002 mm to 0.2 mm.

11. The device shell according to claim 9, wherein the ink layer comprises a metallic ink layer.

12. A device shell processed by the method according to claim 2, wherein the adhesive is of a thickness ranging from 0.002 mm to 0.2 mm.

13. A device, comprising the device shell according to claim 9.

14. The device according to claim 13, wherein the ink layer is of a thickness ranging from 0.002 mm to 0.2 mm.

15. The device according to claim 13, wherein the ink layer comprises a metallic ink layer.

16. The device according to claim 13, wherein the membrane is attached to the outer surface such that the ink layer is in contact with the outer surface.
